(19) United States
(12) Patent Application Publication
(10) Pub. No.: US 2013/0009081 A1
(43) Pub. Date: Jan. 10, 2013

(54) Solenoid Valve and Driver Assistance Device Comprising said type of Solenoid Valve

(75) Inventors: Andreas Karl, Benningen/Neckar (DE); Stephan Steingass, Bornheim (DE); Elmar Vier, Freiberg A.N. (DE)

(73) Assignee: Robert Bosch GmbH, Stuttgart (DE)

(21) Appl. No.: 13/520,059

(22) PCT Filed: Nov. 4, 2010
(86) PCT No.: PCT/EP2010/066793

§ 371 Date: Jun. 29, 2012

(30) Foreign Application Priority Data
Dec. 29, 2009 (DE) 10 2009 055 365.7

(51) Int. Cl. F16K 31/02

(52) U.S. Cl. 251/129.01

(57) ABSTRACT

A solenoid valve includes an armature which is arranged in the region of at least one magnetic coil. At least one radial recess extending essentially in the radial direction, traversing at least in parts the front surface of the armature is provided. A driver assistance device including said type of solenoid valve is also disclosed.

The invention relates to a solenoid valve comprising a solenoid armature arranged in the region of at least one solenoid. The invention also relates to a driver assistance device.

### PRIOR ART

Solenoid valves of the type mentioned at the beginning are known from the prior art. They are used, for example, for driver assistance devices, for example, ABS, TCS or ESP devices. The solenoid valves contain a solenoid armature which is formed in the region of the at least one solenoid and serves for opening and closing the solenoid valve. The solenoid armature can for this purpose be preferably moved in the axial direction by means of the solenoid. This means that said solenoid armature can be moved at least into a closed position and a release position. In the closed position, the solenoid valve is non-transmissive, and a fluid therefore cannot flow from an inlet to an outlet of the solenoid valve. In contrast, in the release position if there is fluid connection between the inlet and the outlet, the solenoid valve is therefore transmissive for the fluid. In this context, either the closed position or the release position forms an output position of the solenoid armature, into which position said solenoid armature is forced by a restoring device, if the solenoid is not energized, that is to say is currentless. Energizing the solenoid causes the solenoid armature to be able to be moved in the direction of the respective other position.

The solenoid armature therefore serves to transmit an electronic force to a closing element of the solenoid valve. The closing element interacts, for example, with a valve seat in order to bring about the closing or release of the solenoid valve. In order to permit the solenoid armature to be oriented during its manufacture and/or to permit the solenoid valve to be assembled, the solenoid armature frequently has in the region of its lateral face a recess into which a corresponding opposing element can engage, and which therefore serves to orient the solenoid armature. This can ensure, for example, that the solenoid armature is securely gripped by an automatic transportation or assembly device. On the other hand, a housing of the solenoid valve can also have the corresponding opposing element which engages in the recess and therefore permits the solenoid armature to be oriented within the solenoid valve. However, it is frequently not possible to arrange the recess on the lateral face of the solenoid armature or to provide the recess with sufficiently large dimensions to be able to carry out the required functionality (transportation, orientation and the like) in a reliable and efficient way.

### DISCLOSURE OF THE INVENTION

In contrast, the solenoid valve comprising the features specified in claim 1 has the advantage that in all cases satisfactory handling of the solenoid armature, in particular in terms of transportation and/or orientation, is possible. This is achieved according to the invention by means of at least one radial recess which penetrates an end face of the solenoid armature at least in certain areas and extends mainly in the radial direction. For this purpose, the solenoid armature is embodied, for example, as a closed cap or has a cylindrical or hollow-cylindrical form at least in certain areas. The region of the end face, in which the radial recess is formed is preferably completely planar. However, it can also be provided that the end face is curved or round or is planar only in a central region and is rounded or beveled in a region where the end face connects with the lateral face.

The radial recess needs to be provided in the end face. Said radial recess penetrates the end face at least in certain areas and in doing so preferably also contacts a central region, that is to say the center of the end face. However, the radial recess can alternatively also be annular or in the form of an annular section with the result that the radial recess engages around the center of the end face at least in certain areas but does not pass through it or contact it. In doing so, the radial recess runs in the radial direction on the end face, that is to say has at least one radial component. All that is meant by this is that the radial recess has its largest dimension in a direction which is unequal to the axial direction of the solenoid armature. The axial direction runs in the direction of the longitudinal axis of the solenoid valve or of the solenoid armature here.

One development of the invention provides that the radial recess has a larger extent in the radial direction than in the axial direction. Radial direction is to be understood here as a direction which is perpendicular to the axial direction, that is to say to an axis which is parallel to the central axis, but otherwise runs in any desired fashion. In particular, said radial recess does not have to intersect the center of the end face of the solenoid armature (with a virtual straight line which extends the radial recess). This definition delineates the radial recess from an axial recess which can be present, for example, on the lateral face of the solenoid armature.

One development of the invention provides that the radial recess is round or rectangular at least in certain areas when viewed in the longitudinal direction. The longitudinal section is understood here to mean a section through the radial recess which is perpendicular to the direction of the largest extent of the radial recess. If the radial recess is round at least in certain areas, it is possible, for example, to provide an oval form of the radial recess at least in certain areas. The radial recess can likewise be rectangular at least in certain areas, that is to say have planar faces which meet one another at a right angle.

One development of the invention provides that the radial recess is present at least in certain areas as a groove, notch or channel or in the form of a circular cylinder, cone or truncated cone. The groove is to be understood here as a rectangular recess. It has preferably two planar side faces and one planar base face, wherein the side faces are perpendicular to the base face. The side faces run here into the end face of the solenoid armature, while the base face is provided offset with respect to the latter in the axial direction. In the embodiment as a notch, this base face is absent, with the result that the side faces meet one another in order to form an outline of the radial recess. Said outline is therefore triangular in the longitudinal section of the radial recess. In the case of the groove, the base face is round or oval at least in certain areas. In this context, the base face can open directly into the end face of the solenoid armature. Alternatively, side faces may adjoin the base face. Alternatively, the radial recess may be provided as a circular cylinder, cone or truncated cone. The center point of the respective form preferably coincides here with the center of the end face, with the result that the radial recess contacts the latter. However, an off-center arrangement is also alternatively possible.

One development of the invention provides that a plurality of radial recesses are provided spaced apart from one another and/or opening one into the other. In this context, the radial recesses may perfectly well be embodied in different ways. For example, a first radial recess may be embodied in the form of a truncated cone centrally on the end face and a further radial recess may pass in the radial direction, in particular completely, as a groove through the end face of the solenoid armature. In this context, the second radial recess runs through the first, that is to say opens into the latter. If a plurality of radial recesses are provided, they preferably have the same depth, that is to say the same extent in the axial direction. However, different depths may also be provided. This is the case, in particular, if the radial recesses are spaced apart from one another. For example, a plurality of, that is to say at least two, circular-ring-formed radial recesses may be provided on the end face of the solenoid armature. These circular-ring-formed radial recesses may be embodied in the longitudinal section as a groove, notch or channel. In particular there is provision that the radial recesses are embodied in different ways, for example one radial recess is embodied as a groove and a further as a channel.

One development of the invention provides that the solenoid armature has at least one axial recess provided on its lateral face. Such an axial recess is known in principle from the prior art but not in conjunction with the radial recess according to the invention. The axial recess should therefore be provided on the lateral face and the radial recess should be provided on the end face. As an alternative to the axial recess, circumferential recesses may also be provided on the lateral face, which circumferential recesses are provided in the lateral face at least in certain areas over the circumference of the solenoid armature.

One development of the invention provides that the radial recess opens into the axial recess. This provides a junction between the radial recess and the axial recess. Alternatively, the radial recess and the axial recess can, of course, be provided separately from one another, that is to say not open one into the other.

One development of the invention provides at least one engagement device which interacts with the radial recess and/or the axial recess in order to orient the solenoid valve and is attached in a fixed fashion in the solenoid valve. The engagement device engages at least in certain areas in the radial recess and/or the axial recess as soon as the solenoid armature is arranged in the solenoid valve. In this way, guidance or orientation of the solenoid valve with respect to further elements of the solenoid valve can be achieved. The engagement device can therefore also serve as a guiding device. In this context, the engagement device is mounted in the solenoid valve in such a way that said engagement device can interact with the radial recess or the axial recess.

One development of the invention provides that the axial recess is a through-flow opening. In order to prevent different pressures from being present or coming about on the two sides of the solenoid armature, when viewed in the axial direction, the axial recess is used as a through-flow opening. In this case it is advantageous if an engagement device which is possibly present interacts only with the radial recess on the end face of the solenoid armature in order to avoid blocking the axial recess. The radial recess is therefore used in this case to orient the solenoid armature, while the axial recess serves to equalize the pressure around the solenoid armature. The pressure equalization is achieved by virtue of the fact that fluid can flow from one side to the other side of the solenoid armature through the through-flow opening.

The invention also relates to a driver assistance device, in particular an ABS, TCS or ESP device, having at least one solenoid valve, in particular in accordance with the abovementioned embodiments, wherein the solenoid valve has a solenoid armature which is arranged in the region of at least one solenoid. In this context, at least one radial recess which penetrates an end face of the solenoid armature at least in certain areas and extends mainly in the radial direction is provided. The described solenoid valves can be used particularly advantageously for such a driver assistance device. In this context, the solenoid armature of the solenoid valve and, in particular, the lateral face thereof can be matched to the requirements of the driver assistance device. In order to simplify the transportation and/or orientation of the solenoid armature, essentially the radial recess is accordingly provided. In addition, at least one axial recess can also be provided on the lateral face of the solenoid armature, which axial recess then serves, in particular, as a through-flow opening.

The invention will be explained in more detail below on the basis of the exemplary embodiments illustrated in the drawing, without the invention being restricted. In the said drawing:

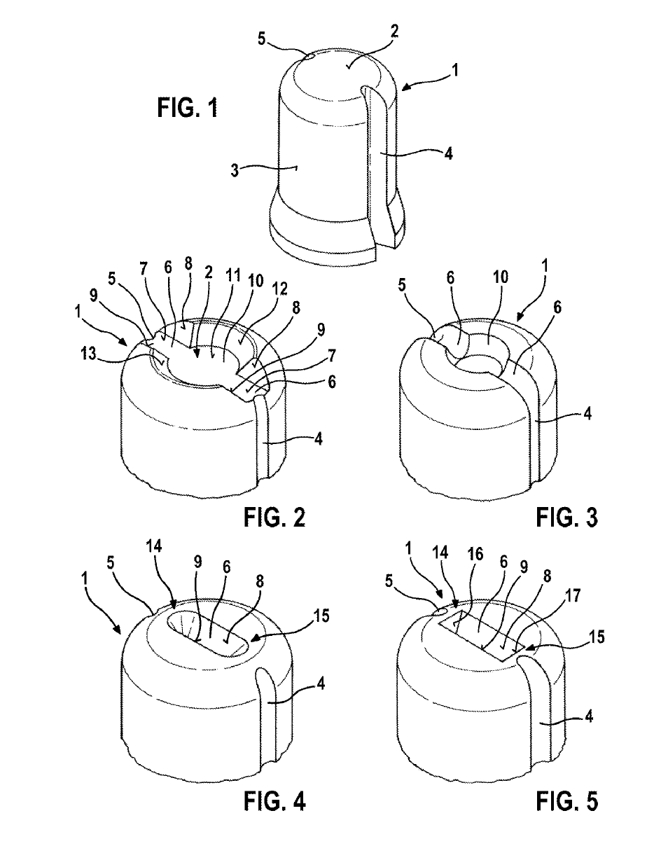

FIG. 1 shows a solenoid armature, not according to the invention, of a solenoid valve,

FIG. 2 shows a region of a solenoid armature according to the invention in a first embodiment,

FIG. 3 shows the region of the solenoid armature in a second embodiment,

FIG. 4 shows the region of the solenoid armature in a third embodiment, and

FIG. 5 shows the region of the solenoid armature in a fourth embodiment.

FIG. 1 shows a solenoid armature 1 of a solenoid valve (not illustrated here) in an embodiment which is not according to the invention. The solenoid armature 1 is embodied in the form of a closed cap, that is to say essentially in the form of a hollow cylinder, wherein one side of the solenoid armature 1 is closed and forms an end face 2 of the solenoid armature 1. The solenoid armature 1 is bounded in the radial direction by its lateral face 3. The solenoid armature 1 has an essentially circular cross section in the longitudinal section. In contrast with the latter, in the lateral face 3 there are axial recesses 4 and 5 which lie diametrically opposite one another. The axial recesses and 5 have their greatest extent in the axial direction and engage in the end face 2 in the radial direction. As is apparent from FIG. 1, the axial recesses 4 and 5 each open into the end face 2. The axial recesses 4 and 5 serve, for example, for transportation and/or orientation during mounting of the solenoid armature 1 in the solenoid valve. They are therefore configured, in particular, to interact with an automatic transportation device and/or assembly device.

In addition, the axial recesses may be configured as through-flow openings. This means that a fluid can flow through the axial recesses 4 and 5 from one side of the solenoid armature 1 to the other, or vice versa, if a pressure gradient is present between the two sides. In particular, if the axial recesses 4 and 5 are to be used as through-flow openings, the solenoid valve must not have any engagement device which engages in the axial recesses 4 and/or 5, in order, for example to orient the solenoid armature 1 and hold it in a specific position in the solenoid valve.

For this reason there is provision for at least one first radial recess 6 to be provided in the end face 2 of the solenoid armature 1 in order to permit the solenoid armature 1 to be oriented within the solenoid valve, or in order to implement such orientation during a manufacturing process of the solenoid armature 1. This is illustrated in FIG. 2, which shows a region of an embodiment of the solenoid armature 1 according to the invention. The first radial recess 6 is embodied essentially as a groove. It has a base face 7 and two side faces 8 and 9, wherein the side faces 8 and 9 open into the end face 2, and the base face 7 runs parallel to the end face. The radial recess 6 engages completely through the end face 2 in the radial direction here. In this context, it opens into the axial recesses 4 and 5. In the illustrated embodiment, the side faces 8 and 9 are present at an angle which is unequal to 90° with respect to the base face 7.

In addition, a second radial recess 10 is provided in the end face 2. Said end face 2 is provided in the form of a truncated cone. The center point of this truncated cone coincides with a center of the end face 2. The radial recess 10 is therefore arranged centerally on the end face 2. The radial recess 10 has a base face 11 and side faces 12 and 13. The base face 11 of the radial recess 10 forms here a continuous face with the base face 7 of the radial recess 6. The radial recesses 6 and 10 have to this extent the same depth, that is to say the same extent in the axial direction of the solenoid armature 1. The first radial recess 6 passes through the second radial recess 10, that is to say is composed of two parts which are present on each side of the second radial recess 10. The radial recess 10 forms a transportation recess for the solenoid armature 1.

FIG. 3 shows a second embodiment of the solenoid armature 1. In this context, the first radial recess 6 and the second radial recess 10 are in turn provided. The axial recesses 4 and 5 also open again into the radial recess 6. The difference from the embodiment in FIG. 2 consists in the fact that the radius of the second radial recess 10 is made smaller, and the first radial recess 6 is made narrower.

FIG. 4 shows a third embodiment of the solenoid armature 1. The first radial recess 6 is present in the form of a notch. The radial recess 6 engages only partially through the end face 2 in the radial direction. It therefore does not open into the axial recesses 4 and 5. In the end regions 14 and 15 thereof (with respect to the longitudinal extent of the radial recess 6), radii are present via which the side faces 8 and 9 join one another. The radial recess 6 is therefore only partially in the form of a notch, and cone sections are respectively present in the end regions 14 and 15.

FIG. 5 shows a fourth embodiment of the solenoid armature 1. The latter is in principle of similar design to the embodiment which was described with respect to FIG. 4. The radial recess 6 does not open into the axial recesses 4 and 5 here either, and accordingly does not pass completely through the end face 2 in the radial direction. The radial recess 6 is in turn present in the form of the notch; however there is no radius provided in the end regions 14 and 15 but rather the notch is bounded by means of planar end faces 16 and 17.

1. A solenoid valve comprising a solenoid armature arranged in the region of at least one solenoid, wherein the solenoid armature defines at least one radial recess which penetrates an end face of the solenoid armature at least in certain areas and extends mainly in the radial direction.

2. The solenoid valve as claimed in claim 1, wherein the radial recess has a larger extent in the radial direction than in the axial direction.

3. The solenoid valve as claimed in claim 1, wherein the radial recess is round or rectangular at least in certain areas when viewed in the longitudinal direction.

4. The solenoid valve as claimed in, claim 1, wherein the radial recess is configured at least in certain areas as a groove, notch or channel or in the form of a circular cylinder, cone or truncated cone.

5. The solenoid valve as claimed in claim 1, wherein the at least one radial recess includes a plurality of radial recesses that are spaced apart from one another and/or opening one into the other.

6. The solenoid valve as claimed in claim 1, wherein the solenoid armature further defines at least one axial recess provided on its lateral face.

7. The solenoid valve as claimed in claim 6, wherein the radial recess opens into the axial recess.

8. The solenoid valve as claimed in claim 1, further comprising at least one engagement device which interacts with the radial recess and/or the axial recess so as to orient the solenoid armature and is attached in a fixed fashion in the solenoid valve.

9. The solenoid valve as claimed in claim 8, wherein the axial recess is a through-flow opening.

10. A driver assistance device having at least one solenoid valve, wherein the solenoid valve has a solenoid armature which is arranged in the region of at least one solenoid, and wherein the solenoid armature defines at least one radial recess which penetrates an end face of the solenoid armature at least in certain areas and extends mainly in the radial direction.

11. The driver assistance device as claimed in claim 10, wherein the driver assistance device is one of an ABS, TCS, and ESP device.
